(19) United States
(12) Patent Application Publication
(10) Pub. No.: US 2022/0210164 A1
(43) Pub. Date: Jun. 30, 2022

(54) APPARATUS AND METHOD FOR MANAGING REMOTE ATTESTATION

(71) Applicant: Electronics and Telecommunications Research Institute, Daejeon (KR)

(72) Inventors: Jae-Deok LIM, Daejeon (KR); Kyeong-Tae KIM, Daejeon (KR); Young-Ho KIM, Daejeon (KR); Jeong-Nyeo KIM, Daejeon (KR); Seon-Gyoung SOHN, Daejeon (KR); Yun-Kyung LEE, Daejeon (KR)

(73) Assignee: Electronics and Telecommunications Research Institute, Daejeon (KR)

(21) Appl. No.: 17/334,051

(22) Filed: May 28, 2021

(30) Foreign Application Priority Data
Dec. 30, 2020 (KR) 10-2020-0187070

(51) Int. Cl. H04L 29/06

(52) U.S. Cl. CPC H04L 63/123; H04L 63/126; H04L 63/0435

(57) ABSTRACT

Disclosed herein are an apparatus and method for managing remote attestation. The apparatus includes one or more processors and executable memory for storing at least one program executed by the one or more processors. The at least one program may request a gateway to verify the integrity of devices connected with the gateway, receive a verification result about whether the integrity of the devices is damaged from the gateway, identify a device, the integrity of which is damaged, using the verification result, perform detailed integrity verification on the device, the integrity of which is damaged, in order to identify an object, the integrity of which is damaged, and perform an operation for responding to the object, the integrity of which is damaged.

### CROSS REFERENCE TO RELATED APPLICATION

This application claims the benefit of Korean Patent Application No. 10-2020-0187070, filed Dec. 30, 2020, which is hereby incorporated by reference in its entirety into this application.

### BACKGROUND OF THE INVENTION

### 1. Technical Field

The present invention relates generally to technology for remote attestation over a network, and more particularly to technology for managing remote attestation for checking the state of integrity of a device.

### 2. Description of the Related Art

Generally, remote attestation is technology configured such that the security of the target to be checked (e.g., a device) is checked and determined by a separate agent at a remote site. The state of the device to be checked is not determined by the device itself, and it is impossible to completely deceive the agent (e.g., a verifier) checking the device merely by manipulating the device. For remote attestation, the target of remote attestation (the attestor, which is typically a device) is fundamentally separated from a verifier (mainly, a remote attestation manager or a remote attestation management server) for verifying the state of integrity of the device through remote attestation, and the attestation value, based on which the state of integrity of the device at the time of verification can be checked, is generated by the device, which is the target of remote attestation, and is then transmitted to the remote attestation manager. As the attestation value for proving the integrity of the device, the hash values of attestation targets in the device (e.g., firmware, a boot image, important executable files, settings configuration files, and the like) are commonly used, and the hash value of the attestation target in a normal state is set as a reference value and is compared with a received current hash value, whereby the state of integrity of the device is verified.

When remote attestation is performed, it is necessary to consider ways to securely generate the attestation value for proving the security of the device, to enable the verifier receiving the attestation value of the device to identify the entity that transmitted the attestation value, to securely deliver the attestation value, and the like.

Here, the attestation value may be securely generated in the device based on any of various methods using a TPM, ROM, or the like depending on the characteristics of the device, the entity that transmitted the attestation value may be identified using the certificate of the entity, and the attestation value may be securely delivered in an environment in which an existing security protocol, such as TLS or the like, is applied.

Conventional technology for providing a method of remote attestation for a large number of devices is configured to perform remote attestation between devices adjacent to each other in a network environment based on mesh network topology. Here, a comprehensive result, based on which only information about whether the devices are corrupted can be checked, is shared, and detailed verification results for respective objects in each of the devices cannot be checked.

Also, because the conventional method is performed in a network environment based on mesh topology in order to perform remote attestation between devices adjacent to each other, it is difficult to use the conventional method in a currently widely used IoT environment in which IoT devices are connected to the Internet through Wi-Fi and APs.

Meanwhile. Korean Patent Application Publication No. 10-2020-0087666, titled “AMI device, and AMI device integrity verification system and method” discloses an Advanced Metering Infrastructure (AMI) device for remote electricity meter reading and a system and method for verifying the integrity of the AMI device using a blockchain in order to be prepared for tampering with the AMI device and failure thereof.

### SUMMARY OF THE INVENTION

An object of the present invention is to improve an existing structure in which a single server directly performs remote attestation on end devices and manages the results of the remote attestation.

Another object of the present invention is to significantly reduce the load of processing remote attestation, which is increasing with the growing scale of IoT, thereby enabling remote attestation to be performed on a large number of devices even in future environments in which the scale of IoT is expected to increase.

A further object of the present invention is to obviate the need to maintain a continuous network channel between a server in the Internet domain and end devices in a local network domain, thereby reducing the load imposed due to the use of the network and the use of resources of the devices and the management server.

In order to accomplish the above objects, an apparatus for managing remote attestation according to an embodiment of the present invention includes one or more processors and executable memory for storing at least one program executed by the one or more processors. The at least one program may request a gateway to verify the integrity of devices connected with the gateway, receive a verification result about whether the integrity of the devices is damaged from the gateway, identify a device, the integrity of which is damaged, using the verification result, perform detailed integrity verification on the device, the integrity of which is damaged, in order to identify an object, the integrity of which is damaged, and perform an operation for responding to the object, the integrity of which is damaged.

Here, the gateway may verify whether the integrity of the devices is damaged using first attestation values received from the devices and first reference values previously received from the devices and registered in advance.

Here, the gateway may decrypt the encrypted first attestation values using first encryption keys previously registered and shared with the devices.

Here, the verification result about whether the integrity of the devices is damaged may include the identifier of the gateway, the identifier of the device, the integrity of which is damaged, and a first attestation value received from the device, the integrity of which is damaged.

Here, the at least one program may perform the detailed integrity verification on the devices using a second attestation value received from the device, the integrity of which is damaged, and second reference values previously received from the devices and registered in advance.

Here, the at least one program may decrypt the encrypted second attestation value using a second encryption key previously registered and shared with the device, the integrity of which is damaged.

Here, the at least one program may check whether a change in the state of the object, the integrity of which is damaged, is approved, and may update the first reference value and the second reference value with the first attestation value and the second attestation value, respectively, when it is determined that the change is a previously approved change.

Here, the at least one program may check whether the change in the state of the object, the integrity of which is damaged, is approved, and may perform recovery of the device, the integrity of which is damaged, using the first reference value and the second reference value when it is determined that the change is not a previously approved change.

Also, in order to accomplish the above objects, a method for managing remote attestation, performed by a remote attestation management apparatus, according to an embodiment of the present invention includes requesting a gateway to verify the integrity of devices connected with the gateway, receiving a verification result about whether the integrity of the devices is damaged from the gateway, identifying a device, the integrity of which is damaged, using the verification result, performing detailed integrity verification on the device, the integrity of which is damaged, in order to identify an object, the integrity of which is damaged, and performing an operation for responding to the object, the integrity of which is damaged.

Here, identifying the device, the integrity of which is damaged, may be configured such that the gateway verifies whether the integrity of the devices is damaged using first attestation values received from the devices and first reference values previously received from the devices and registered in advance.

Here, identifying the device, the integrity of which is damaged, may be configured such that the gateway decrypts the encrypted first attestation values using first encryption keys previously registered and shared with the devices.

Here, the verification result about whether the integrity of the devices is damaged may include the identifier of the gateway, the identifier of the device, the integrity of which is damaged, and a first attestation value received from the device, the integrity of which is damaged.

Here, performing the operation for responding to the object, the integrity of which is damaged, may be configured to perform the detailed integrity verification of the devices using a second attestation value received from the device, the integrity of which is damaged, and second reference values previously received from the devices and registered in advance.

Here, performing the operation for responding to the object, the integrity of which is damaged, may be configured to decrypt the encrypted second attestation value using a second encryption key previously registered and shared with the device, the integrity of which is damaged.

Here, performing the operation for responding to the object, the integrity of which is damaged, may be configured to check whether a change in the state of the object, the integrity of which is damaged, is approved, and to update the first reference value and the second reference value with the first attestation value and the second attestation value, respectively, when it is determined that the change is a previously approved change.

Here, performing the operation for responding to the object, the integrity of which is damaged, may be configured to check whether the change in the state of the object, the integrity of which is damaged, is approved, and to perform recovery of the device, the integrity of which is damaged, using the first reference value and the second reference value when it is determined that the change is not a previously approved change.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a block diagram illustrating a system for managing remote attestation according to an embodiment of the present invention;

FIG. 2 is a sequence diagram illustrating a method for managing remote attestation according to an embodiment of the present invention;

FIG. 3 is a sequence diagram illustrating a device registration process in a method for managing remote attestation according to an embodiment of the present invention:

FIG. 4 is a table illustrating device registration information according to an embodiment of the present invention:

FIG. 5 and FIG. 6 are tables illustrating detailed verification information of a device according to an embodiment of the present invention:

FIG. 7 is a sequence diagram illustrating a comprehensive verification process in a method for managing remote attestation according to an embodiment of the present invention;

FIG. 8 is a sequence diagram illustrating a detailed verification process in a method for managing remote attestation according to an embodiment of the present invention; and

FIG. 9 is a view illustrating a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations that have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present invention will be described in detail with reference to the accompanying drawings.

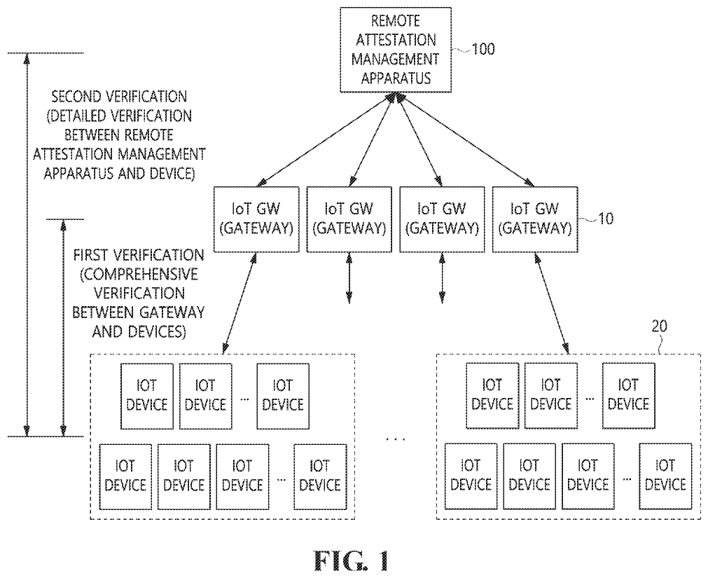

FIG. 1 is a block diagram illustrating a system for managing remote attestation according to an embodiment of the present invention.

Referring to FIG. 1, the system for managing remote attestation according to an embodiment of the present invention includes an IoT gateway 10, IoT devices 20, and a remote attestation management apparatus 100.

The remote attestation management apparatus 100 may perform comprehensive verification, which is first verification for the ToT devices 20, using the gateway 10, and may perform detailed verification, which is second verification for the devices.

The gateway 10 may manage a remote attestation state for the devices connected thereto, and may perform comprehensive verification between the gateway 10 and the devices 20, which is the first verification.

Each of the devices 20 may generate an integrity verification value, based on which the state of integrity thereof can be verified, and provide the same in response to a request for integrity verification. The integrity verification value may be classified as a comprehensive attestation value used for the first verification or an individual attestation value used for the second verification.

As the comprehensive attestation value, a chained hash value that is formed by connecting the respective hash values of the targets that need to be verified in the device (e.g., firmware, a boot image, important executable files, settings configuration files, and the like) may be used.

Because the final value of such a chained hash value used as a comprehensive attestation value is changed even when only one of the targets to be verified in a device is changed, whether the targets to be verified in the device are corrupted may be checked at once through a single comparison process, whereby whether the integrity of the device is maintained may be quickly checked.

As the individual attestation value, the hash value of each of the targets to be verified may be used. A hash value is a most commonly used means for checking the state of integrity, and another means enabling the state of integrity of a device to be checked may be used instead.

Comprehensive verification performed in the first verification process between the gateway 10 and the device 20 may be a verification process for simply checking the state of integrity of the device 20, and detailed verification performed in the second verification process between the remote attestation management apparatus 100 and the device 20 may be performed in order to identify a corrupted part in the device 20 and to respond thereto when it is determined that the state of integrity of the device is damaged in the first verification process.

The remote attestation management apparatus 100 performs detailed verification on the device only w % ben the comprehensive verification result is abnormal. Through the result of detailed verification, the remote attestation management apparatus 100 may identify an object, the integrity of which is damaged, and perform an operation for responding thereto.

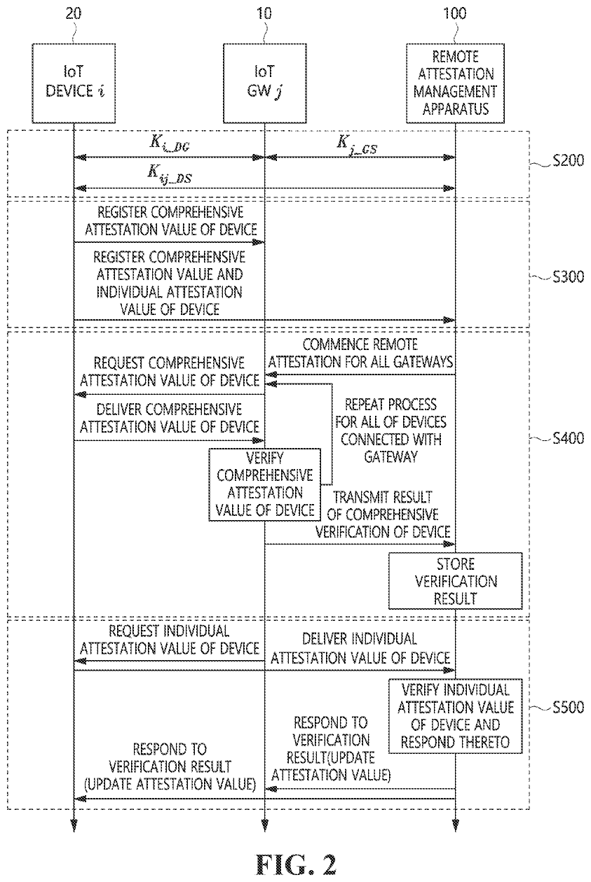

FIG. 2 is a sequence diagram illustrating a method for managing remote attestation according to an embodiment of the present invention.

Referring to FIG. 2, in the method for managing remote attestation according to an embodiment of the present invention, first, an encryption key may be shared at step S200.

That is, at step S200, an encryption key may be shared using existing standard protocols (e.g., PANA, TLS, or the like) in order to protect messages transmitted in respective sections.

Messages transmitted and received in the following steps may be encrypted and decrypted using the shared encryption key.

Here, it can be seen that a gateway 10 and a device 20 share the encryption key K_{i_DG} therebetween, the gateway 10 and a remote attestation management apparatus 100 share the encryption key K_{j_GS} therebetween, and the device 20 and the remote attestation management apparatus 100 share the encryption key K_{ij_DS} therebetween.

Also, in the method for managing remote attestation according to an embodiment of the present invention, the device may be registered at step S300.

That is, at step S300, the reference value to be used in a remote attestation process may be registered along with basic information for device connection in order to manage remote attestation.

A reference comprehensive attestation value (a first reference value) may be registered both in the gateway 10, to which the device 20 is connected, and in the remote attestation management apparatus 100, and a reference individual attestation value (a second reference value) may be registered only in the remote attestation management apparatus 100.

Here, because step S300 is commonly performed when the device 20 is installed in an IoT service and first operated, invasion from the outside rarely occurs at this step. Therefore, the comprehensive and individual attestation values calculated at this time may be registered as the reference values to be used for the following remote attestation process.

Also, in the method for managing remote attestation according to an embodiment of the present invention, comprehensive verification, which is the first verification phase of remote attestation, may be performed at step S400.

Remote attestation may be performed periodically by the remote attestation management apparatus 100, or may be performed only for a specified device 20 when necessary. Here, periodic remote attestation is performed on all of the devices 20, but the procedure thereof is the same as the procedure of remote attestation performed on the specified device. Therefore, only periodic remote attestation will be described below.

At step S400, when a remote attestation period lapses, the remote attestation management apparatus 100 may simultaneously request all of the gateways connected thereto to perform remote attestation in order to perform remote attestation on all of the devices.

Here, at step S400, the remote attestation management apparatus 100 may request each of the gateways 10 to verify the integrity of the devices connected with the gateway.

Here, at step S400, the gateway 10 may request comprehensive attestation values from the devices 20.

Here, at step S400, the devices 20 may calculate the comprehensive attestation values thereof and transmit the same to the gateway 10.

Here, at step S400, the gateway 10 may verify whether the integrity of the devices is damaged using the comprehensive attestation values received from the devices 20 and the first reference values previously received from the devices 20 and registered in advance.

Here, at step S400, the remote attestation management apparatus 100 may receive the verification result about whether the integrity of the devices 20 is damaged from the gateway 10.

Here, the verification result about whether the integrity of the devices is damaged may include the identifier of the gateway, the identifier of the device, the integrity of which is damaged, and the comprehensive attestation value received from the device, the integrity of which is damaged.

Here, at step S400, the remote attestation management apparatus 100 may identify the device, the integrity of which is damaged, using the verification result.

Here, at step S400, the remote attestation management apparatus 100 may store the verification result about whether the integrity of each of the devices is damaged.

As described above, comprehensive verification is performed between the gateway 10 and the devices 20 connected thereto. That is, because comprehensive verification and transmission of the verification results are performed by the respective gateways 10, even if the number of devices 20 is increased, remote attestation may be processed faster than in the case in which the remote attestation management apparatus 100 directly performs remote attestation on all of the devices 20, whereby the load on the remote attestation management apparatus 100 may be significantly reduced.

Also, in the method for managing remote attestation according to an embodiment of the present invention, detailed verification, which is the second verification phase of remote attestation, may be performed at step S500.

That is, at step S500, when it is determined at the first verification phase that all of the devices 20 are normal, the remote attestation process at the gateway 10 is finished, whereas when it is determined that a corrupted device 20 is present, detailed verification, which is the second verification phase, may be performed.

Here, at step S500, because the gateway 10 is made aware of the corrupted device using the result of the first verification phase, the gateway 10 may request an individual attestation value from the corresponding device 20.

Here, because the gateway 10 is a device that supports connection of the device 20 to the Internet, allowing the gateway 10 to manage information about the targets to be verified in the device may create security vulnerabilities.

Therefore, detailed information, from which information about the device can be inferred, may be managed in the remote attestation management apparatus 100.

Here, at step S500, because the detailed information of each target to be verified in the device 20 is managed by the remote attestation management apparatus 100, the device 20 may calculate the individual attestation value and transmit the same to the remote attestation management apparatus 100.

Here, at step S500, detailed integrity verification for identifying an object, the integrity of which is damaged, is performed, and an operation for responding to the object, the integrity of which is damaged, may be performed.

Here, at step S500, the detailed integrity verification may be performed using the individual attestation values received from the devices including the device whose integrity is damaged and the second reference values previously received from the devices and registered in advance.

Here, at step S500, the remote attestation management apparatus 100 checks the individual attestation value of each of the targets to be verified, thereby identifying the object, the integrity of which is damaged, and checking a change in the state of the corresponding object.

Here, at step S500, whether the change in the state of the object, the integrity of which is damaged, is approved is checked. Here, when the change is a previously approved change, the first reference value and the second reference value may be updated with the comprehensive attestation value and the individual attestation value, respectively.

Here, at step S500, when it is determined that the integrity of the object is damaged due to a normal action (e.g., when an authorized user changes, adds, or deletes a file), the reference values are updated with the currently calculated attestation values so as to be used for subsequent verification.

Here, at step S500, whether the change in the state of the object, the integrity of which is damaged, is approved is checked, and when the change is not a previously approved change, recovery of the device, the integrity of which is damaged, may be performed using the first reference value and the second reference value.

Here, at step S500, when it is determined that the integrity of the object is damaged for a reason other than a normal action, recovery of the device or object may be performed in order to respond to the verification result.

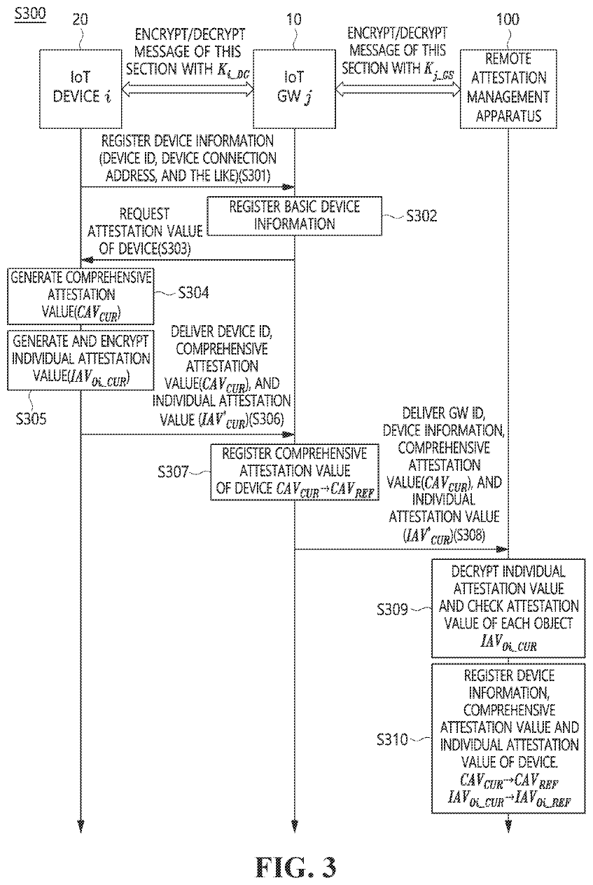

FIG. 3 is a sequence diagram illustrating a device registration process in a method for managing remote attestation according to an embodiment of the present invention.

Referring to FIG. 3, it can be seen that an example of step S300 in FIG. 2 is illustrated in detail.

In the registration process performed at step S300, respective messages may be encrypted with the keys that are shared at step S200.

Messages transmitted and received between the remote attestation management apparatus 100 and the gateway 10 may be encrypted and decrypted using the encryption key K_{j_GS}.

Messages transmitted and received between the gateway 10 and the device 20 may be encrypted and decrypted using the encryption key K_{i_DG}.

The device 20 may deliver basic device information, including at least the device ID for identifying the device and a device connection address for connection with the device, to the gateway 10 to which the device 20 is connected at step S301.

The gateway 10 may register the received basic device information in the form of a database, a file, or the like in the gateway at step S302.

After it registers the basic device information, the gateway 10 may request a device attestation value to be used for remote attestation at step S303.

In response to the request for the attestation value, the device 20 may generate a reference comprehensive attestation value and a reference individual attestation value as reference values at step S304.

Here, at step S304, the device 20 may generate a reference Comprehensive Attestation Value (CAV) based on Equation (1) using a chained hash value for all of the targets to be verified in the device.

CAV_{CUR}=H( . . . H(H(0∥O₁)∥O₂) . . . ∥Oₙ) (1)

In Equation (1), the reference comprehensive attestation value CAV_{CUR} denotes the currently calculated reference comprehensive attestation value, H denotes a hash function, Oᵢ denotes the i-th target (object) to be verified, and ‘∥’ denotes a simple string concatenation.

The device 20 may calculate a reference Individual Attestation Value (IAV) for each of the targets to be verified using a hash function, and may generate an encrypted message as shown in Equation (2) for device registration at step S305.

Here, the device 20 may encrypt the reference individual attestation value with the encryption key K_{ij_DS} shared in advance between the device 20 and the remote attestation management apparatus 100 such that the information is checked only by the remote attestation management apparatus 100 while the information is hidden from the gateway 10, to which the information is delivered first.

IAV′_{CUR}=E_K_{ij_DS}([OID₁∥IAV_{O1_CUR}]∥[OID₂∥IAV_{O2_CUR}]∥ . . . ∥[OIDₙ∥IAV_{On_CUR}]) (2)

In Equation (2). IAV_{CUR} denotes a message consisting of the currently calculated reference individual attestation values, IAV′_{CUR} denotes a message acquired by encrypting IAV_{CUR}, E_K_{ij_DS} denotes an encryption algorithm using the encryption key K_{ij_DS} shared between the remote attestation management apparatus 100 and the device i, connected with the gateway j 10, OIDᵢ denotes the identifier of Oᵢ, and IAV_{Oi_CUR} denotes the currently calculated hash value H(Oᵢ) for Oᵢ, that is, the individual attestation value of Oᵢ.

The device 20 may deliver the calculated reference comprehensive attestation value and the encrypted message including the reference individual attestation values to the gateway 10 along with the device ID, based on which the device 20 itself can be identified, at step S306.

The gateway 10 may store the received reference comprehensive attestation value of the device 20 as the reference value CAV_{REF} for comprehensive verification, which is to be used for subsequent remote attestation, at step S307.

The gateway 10 may deliver the reference comprehensive attestation value and the encrypted message including the individual attestation values, which are received from the device 20, to the remote attestation management apparatus 100 along with the device information and information about the gateway 10 required for connection with the device at step S308 such that the remote attestation management apparatus 100 is able to manage all of the devices in an integrated manner.

After it decrypts the received encrypted message, which includes the reference individual attestation values, using the encryption key K_{ij_DS} shared with the device 20, the remote attestation management apparatus 100 may check the reference individual attestation value for each of the objects in the device 20 at step S309.

Through the received gateway information and device information, the remote attestation management apparatus 100 may store the reference comprehensive attestation value and the reference individual attestation value as the first reference value and the second reference value for remote attestation at step S310.

Table 1 shows device registration information including the comprehensive attestation value managed in the gateway 10.

TABLE 1

| | | | measured comprehensive | |
|---|---|---|---|---|
| | device connection | reference comprehensive | attestation value | |
| | information | attestation value | (current value) | |
| device ID | (e.g., IP address) | (CAV_{REF}) | (CAV_{CUR}) | . . . |
| IoT101 | 20.20.0.19 | 4f0651d8 . . . 49600b0a | 4f0651d8 . . . 49600b0a | |
| IoT102 | 20.20.0.20 | dbe69e13 . . . 5a76e59c | dbe69e13 . . . 5a76e59c | |
| . . . | . . . | . . . | . . . | |

When device registration information is registered, a measured value and a reference value equal thereto are stored in the gateway 10. Then, when a remote attestation process is performed, a comprehensive attestation value calculated by the device 20 and received therefrom may be stored as the measured comprehensive attestation value of the device. When integrity is maintained, the reference value and the measured value are equal to each other, whereas when the integrity is damaged, the measured value becomes different from the reference value.

Table 2 illustrates an example of device registration information including a comprehensive attestation value managed in the remote attestation management apparatus 100.

TABLE 2

| | | | device | | measured | |
|---|---|---|---|---|---|---|
| | GW | | connection | reference | comprehensive | |
| | connection | | information | comprehensive | attestation value | |
| | information | device | (e.g., IP | attestation value | (current value) | |
| GW ID | (e.g., IP) | ID | address) | (CAV_{REF}) | (CAV_{REF}) | . . . |
| GW123 | 111.222.3.5 | IoT101 | 20.20.0.19 | 4f0651d8 . . . 49600b0a | 4f0651d8 . . . 49600b0a | |
| GW123 | 111.222.3.5 | IoT102 | 20.20.0.20 | dbe69e13 . . . 5a76e59c | dbe69e13 . . . 5a76e59c | |
| | | . . . | . . . | . . . | . . . | |

The device registration information managed in the remote attestation management apparatus 100 is the same as the device registration information managed in the gateway 10, and information about the gateway to which the device is connected is further included so as to enable connection with the device to be established normally.

Table 3 illustrates an example of detailed verification information of each device managed in the remote attestation management apparatus 100.

TABLE 3

| object | | | altered | |
|---|---|---|---|---|
| id (file | | | state | |
| name | reference individual | measured individual | (change, | |
| or the | attestation value | attestation value | addition, | |
| like) | (IAV_{REF}) | (IAV_{CUR}) | deletion) | . . . |
| obj_id1 | 571491d0 . . . d3c3e7c6 | 571491d0 . . . d3c3e7c6 | | |
| obj_id2 | 0f19d87c . . . 06d2f980 | ff19347c . . . 0ae2f923 | CHG | |
| obj_id3 | 571491d0 . . . d3c3e7c6 | — | DEL | |
| obj_id4 | | fc19a47c . . . 0ac2f950 | ADD | |
| . . . | . . . | . . . | | |

In the present invention, an example in which individual attestation values of devices are managed using separate tables for the respective devices is illustrated, but they may be managed using a single detailed verification information table, and the table may be implemented so as to maintain a link to the detailed verification information of a device through device information.

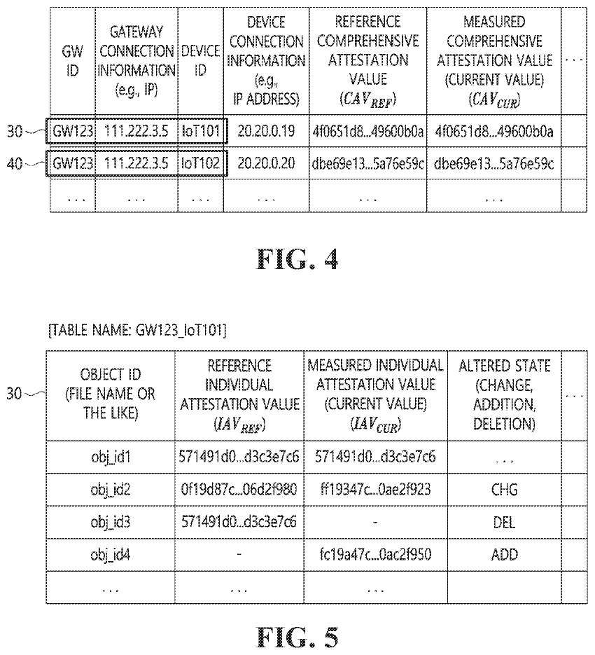

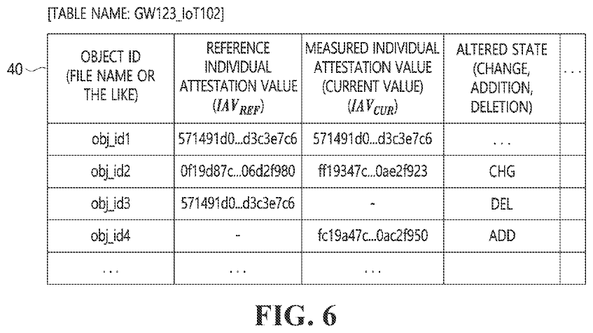

FIG. 4 is a table illustrating device registration information according to an embodiment of the present invention. FIG. 5 and FIG. 6 are tables illustrating detailed verification information of a device according to an embodiment of the present invention.

Referring to FIG. 4, an example in which, when device registration information is managed separately from detailed verification information (30, 40) of respective devices, a connection relationship therebetween is set such that the detailed verification information of the respective devices, shown in FIG. 5 and FIG. 6, can be referred to using the device registration information is illustrated.

The device registration information, including information about devices and comprehensive verification information thereof, is managed using a single table, and may be used in order to check whether the integrity of each of the devices is damaged.

Here, when it is necessary to check the detailed integrity states of the remote attestation targets in each of the devices, the table including the detailed verification information of the device may be referred to using a table name (30 or 40), which is formed by combining the identification information of the gateway 10 (GW ID), to which the device 20 is connected, with the identification information of the device 20 (device ID).

The device registration process for remote attestation is performed such that devices are registered simultaneously when the devices are booted at the time of initial setup of a remote attestation framework, and when a device is added after the setup, registration may be additionally performed through a device registration procedure, whereby the device may be included in the remote attestation management targets.

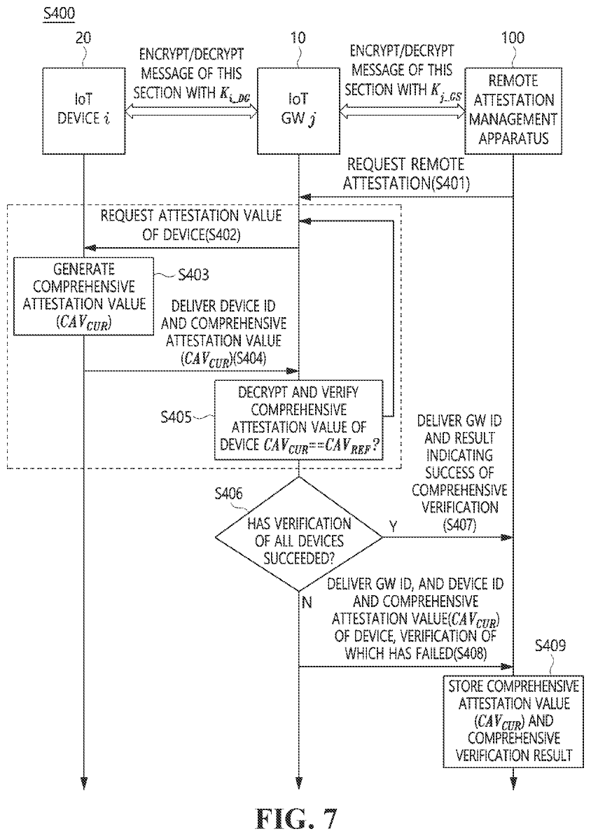

FIG. 7 is a sequence diagram illustrating a comprehensive verification process in a method for managing remote attestation according to an embodiment of the present invention.

Referring to FIG. 7, it can be seen that a detailed procedure of a comprehensive verification phase performed between a gateway 10 and a device 20, which is step S400 in FIG. 2 and the first verification of the remote attestation process, is illustrated.

The remote attestation management apparatus 100 may request remote attestation on all of the registered devices at preset intervals, or may request remote attestation on an arbitrary device in response to a request from an administrator at step S401.

In the case of remote attestation repeatedly performed at preset intervals, the remote attestation management apparatus 100 may request all of the gateways 10 to perform remote attestation on all of the devices 20 connected thereto. In the case of remote attestation for an arbitrary device, the remote attestation management apparatus 100 may request only the gateway 10 to which the target device 20 is connected to perform remote attestation.

Here, the remote attestation management apparatus 100 may acquire information about the gateway, to which the target device 20 is connected, using a management table.

Upon receiving a remote attestation request, which is repeatedly made at a preset interval, the gateway 10 may request device attestation values for remote attestation from all of the devices 20 registered therein using a device registration information management table at step S402.

When it receives a request for remote attestation for an arbitrary device 20, the gateway 10 may request a device attestation value for remote attestation from only the corresponding device 20.

The device 20 that received the request for the device attestation value may generate a comprehensive attestation value thereof based on Equation (1), which is the comprehensive attestation value calculation equation that was used when the device was registered, at step S403.

The device 20 may deliver the generated comprehensive attestation value to the gateway 10 along with the device ID, based on which the device itself can be identified, at step S404.

The gateway 10 may update the measured comprehensive attestation value CAV_{CUR} in the management table with the comprehensive attestation value received from the device 20, and may check whether the integrity of the device is damaged through a comparison with a reference comprehensive attestation value CAV_{RFF} at step S405.

After the remote attestation procedure for all of the devices is completed, the gateway 10 may determine whether integrity is damaged for all of the devices at step S406.

When it is determined that the integrity of the devices is not damaged, the gateway 10 may deliver a GW ID, which is the identification information of the gateway, and a result indicating that the integrity states of all of the devices are normal to the remote attestation management apparatus 100 at step S407.

When a device, the integrity of which is damaged, is present, the gateway may deliver the identification information of the gateway, the identification information of the device, the integrity of which is damaged, and integrity state information including the measured comprehensive attestation value CAV_{CUR} thereof to the remote attestation management apparatus 100 at step S408.

The remote attestation management apparatus 100 may receive the integrity state information and store the same in the management table at step S409.

Here, for the device, the integrity state of which is determined to be normal, the remote attestation management apparatus 100 may record information indicating that the integrity state is normal in the management table and update the time at which remote attestation is performed and the like therein. Also, for the device, the integrity of which is determined to be damaged, the remote attestation management apparatus 100 may record information indicating that the integrity is damaged in the management table and update the measured comprehensive attestation value CAV_{CUR} of the device in the management table.

Here, the remote attestation management apparatus 100 may visualize the content of the management table and display the currently checked remote attestation state on a monitoring screen for an administrator.

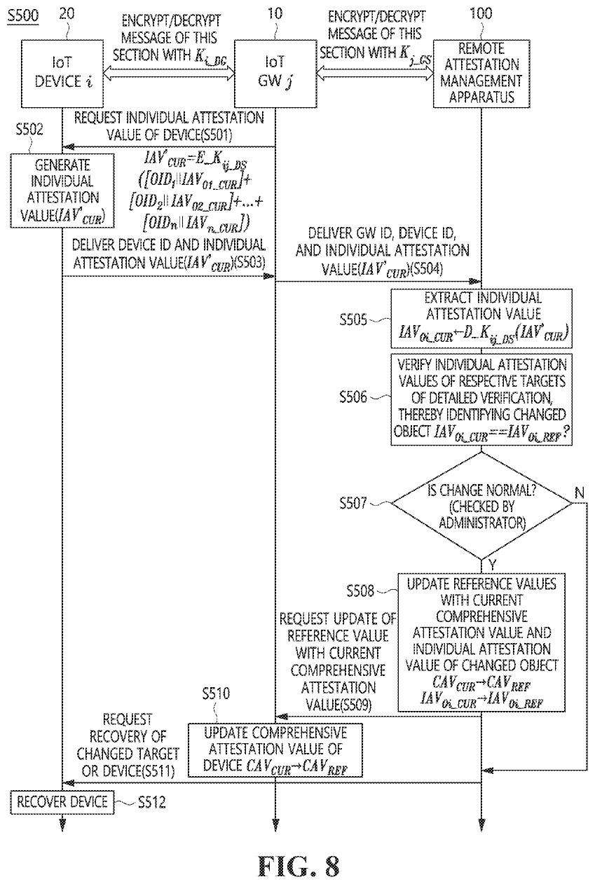

FIG. 8 is a sequence diagram illustrating a detailed verification process of a method for managing remote attestation according to an embodiment of the present invention.

Referring to FIG. 8, it can be seen that an example of step S500 in FIG. 2 is illustrated in detail.

Step S500 is a detailed verification phase, which is second verification for identifying a corrupted object in a device 20 when the integrity of the device 20 is determined to be damaged according to the result of comprehensive verification, which is the first verification phase performed between the gateway 10 and the device 20.

At step S500, the gateway 10 serves only to relay data between the remote attestation management apparatus 100 and the device, and detailed verification may be performed by the remote attestation management apparatus 100.

Also, the measured individual attestation value to be used for detailed verification is encrypted with the encryption key shared in advance between the remote attestation management apparatus 100 and the device 20, whereby information about the remote attestation targets in the device may be protected such that the content thereof is prevented from being made known to the gateway 10.

Second verification is initiated by the gateway 10 when it is determined that a device 20, the integrity of which is damaged, is present after the gateway 10 delivers the first verification result to the remote attestation management apparatus 100, but depending on the circumstances, the remote attestation management apparatus 100 may perform second verification immediately after the first verification is completed.

First, the gateway 10 may request an individual attestation value of the device, which is required for detailed verification, from the device 20, the integrity of which is determined to be damaged in the first verification, at step S501.

The device 20 that received the request for the individual attestation value may generate an individual attestation value thereof using Equation (2), which is the individual attestation value calculation equation that was used when the device was registered, at step S502.

Here, the device 20 may encrypt the individual attestation value, required for detailed verification, with the encryption key shared in advance between the remote attestation management apparatus 100 and the device 20 in order to hide the individual attestation value from the gateway 10.

The device 20 may deliver the identification information thereof (device ID) and the encrypted individual attestation value to the gateway 10 at step S503.

The gateway 10 may deliver the data received from the device to the remote attestation management apparatus 100 along with the identification information thereof (GW ID) at step S504.

The remote attestation management apparatus 100 may decrypt the encrypted measured individual attestation value using the encryption key shared in advance with the corresponding device 20, thereby extracting the measured individual attestation value at step S505.

The remote attestation management apparatus 100 records the extracted measured individual attestation value for each object in the device 20 in the detailed verification information management table for the device and compares the same with the reference individual attestation value, which is registered in advance at step S300, thereby performing detailed verification at step S506.

After it performs detailed verification, the remote attestation management apparatus 100 may update verification state information for checking the state of each object.

For example, the remote attestation management apparatus 100 may record the state ‘CHG’, indicating that an object is changed, in the management table as the ‘altered state’ information when the reference value is different from the measured value, may record the state ‘ADD’, indicating that an object is added, in the management table when on object having no reference value has a measured value, or may record the state ‘DEL’, indicating that an object is deleted, in the management table when an object having a reference value does not have a measured value, as shown in FIG. 5 and FIG. 6.

With regard to the altered object, the remote attestation management apparatus 100 may check whether a change in the state of the object is caused due to a normal procedure at step S507.

When it is determined that the change in the state is caused due to a normal procedure, the remote attestation management apparatus 100 may change the reference values to the currently measured values (the comprehensive attestation value and the individual attestation value) at step S508.

Here, the remote attestation management apparatus 100 may request the gateway 10 to also update the reference value with the currently measured value at step S509.

The gateway 10 updates the reference comprehensive attestation value with the measured comprehensive attestation value at step S510 such that the updated value is referred to for subsequent remote attestation.

Conversely, when the change in the state is determined to be abnormal, the change is determined to be an unapproved change caused due to an outside attack or an error, and the remote attestation management apparatus 100 may request the device 20, the integrity of which is damaged, to perform recovery at step S511.

The device 20 that received the request, such as a recovery instruction or the like, may perform a recovery procedure through firmware update or the like at step S512.

The remote attestation management apparatus 100 may visualize the updated content of the management table and display detailed information about remote attestation states of the device 20 on a monitoring screen for an administrator.

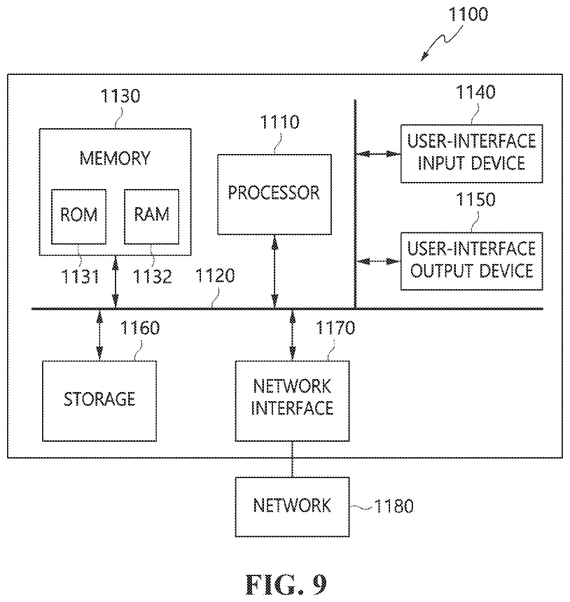

FIG. 9 is a view illustrating a computer system according to an embodiment of the present invention.

Referring to FIG. 9, the remote attestation management apparatus according to an embodiment of the present invention may be implemented in a computer system 1100 including a computer-readable recording medium. As illustrated in FIG. 9, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The remote attestation management apparatus according to an embodiment of the present invention may include one or more processors 1110 and executable memory 1130 for storing at least one program executed by the one or more processors 1110. The at least one program requests a gateway to verify the integrity of devices connected with the gateway, receives a verification result about whether the integrity of the devices is damaged from the gateway, identifies the device, the integrity of which is damaged, using the verification result, performs detailed integrity verification on the device, the integrity of which is damaged, in order to check an object, the integrity of which is damaged, and performs an operation for responding to the object, the integrity of which is damaged.

Here, the gateway may verify whether the integrity of the devices is damaged using first attestation values received from the devices and first reference values previously received from the devices and registered in advance.

Here, the verification result about whether the integrity of the devices is damaged may include the identifier of the gateway, the identifier of the device, the integrity of which is damaged, and the first attestation value received from the device, the integrity of which is damaged.

Here, the at least one program may perform the detailed integrity verification on the devices using second attestation values received from the devices including the device whose integrity is damaged, and second reference values previously received from the devices and registered in advance.

Here, the at least one program may check whether a change in the state of the object, the integrity of which is damaged, is approved, and when it is determined that the change is a previously approved change, the at least one program may update the first reference value and the second reference value with the first attestation value and the second attestation value, respectively.

Here, the at least one program may check whether a change in the state of the object, the integrity of which is damaged, is approved, and when it is determined that the change is not a previously approved change, the at least one program may perform recovery of the device, the integrity of which is damaged, using the first reference value and the second reference value.

The present invention may improve on an existing structure in which a single server directly performs remote attestation on end devices and manages the results of the remote attestation.

Also, the present invention significantly reduces the load of processing remote attestation, which is increasing with the growing scale of IoT, thereby enabling remote attestation to be performed on a large number of devices even in future environments in which the scale of IoT is expected to increase.

Also, the present invention obviates the need to maintain a continuous network channel between a server in the Internet domain and end devices in a local network domain, thereby reducing the load imposed due to the use of the network and the use of resources of the devices and the management server.

As described above, the apparatus and method for managing remote attestation according to the present invention are not limitedly applied to the configurations and operations of the above-described embodiments, but all or some of the embodiments may be selectively combined and configured, so the embodiments may be modified in various ways.

What is claimed is:

1. An apparatus for managing remote attestation, comprising:
one or more processors; and
executable memory for storing at least one program executed by the one or more processors,
wherein the at least one program is configured to
request a gateway to verify integrity of devices connected with the gateway,
receive a verification result about whether the integrity of the devices is damaged from the gateway,
identify a device, integrity of which is damaged, using the verification result,
perform detailed integrity verification on the device, the integrity of which is damaged, in order to identify an object, integrity of which is damaged, of the device and
perform an operation for responding to the object, the integrity of which is damaged.

2. The apparatus of claim 1, wherein the gateway verifies whether the integrity of the devices is damaged using first attestation values received from the devices and first reference values previously received from the devices and registered in advance.

3. The apparatus of claim 2, wherein the gateway decrypts the encrypted first attestation values using first encryption keys previously registered and shared with the devices.

4. The apparatus of claim 3, wherein the verification result about whether the integrity of the devices is damaged includes an identifier of the gateway, an identifier of the device, the integrity of which is damaged, and a first attestation value received from the device, the integrity of which is damaged.

5. The apparatus of claim 1, wherein the at least one program performs the detailed integrity verification on the devices using a second attestation value received from the device, the integrity of which is damaged, and second reference values previously received from the devices and registered in advance.

6. The apparatus of claim 5, wherein the at least one program decrypts the encrypted second attestation value using a second encryption key previously registered and shared with the device, the integrity of which is damaged.

7. The apparatus of claim 6, wherein the at least one program is configured to:
check whether a change in a state of the object, the integrity of which is damaged, is approved, and
update the first reference value and the second reference value with the first attestation value and the second attestation value, respectively, when it is determined that the change is a previously approved change.

8. The apparatus of claim 7, wherein the at least one program is configured to:
check whether the change in the state of the object, the integrity of which is damaged, is approved, and
perform recovery of the device, the integrity of which is damaged, using the first reference value and the second reference value when it is determined that the change is not a previously approved change.

9. A method for managing remote attestation, performed by a remote attestation management apparatus, comprising:
requesting a gateway to verify integrity of devices connected with the gateway,
receiving a verification result about whether the integrity of the devices is damaged from the gateway,
identifying a device, integrity of which is damaged, using the verification result,
performing detailed integrity verification on the device, the integrity of which is damaged, in order to identify an object, integrity of which is damaged, of the device and
performing an operation for responding to the object, the integrity of which is damaged.

10. The method of claim 9, wherein identifying the device, the integrity of which is damaged, is configured such that the gateway verifies whether the integrity of the devices is damaged using first attestation values received from the devices and first reference values previously received from the devices and registered in advance.

11. The method of claim 10, wherein identifying the device, the integrity of which is damaged, is configured such that the gateway decrypts the encrypted first attestation values using first encryption keys previously registered and shared with the devices.

12. The method of claim 11, wherein the verification result about whether the integrity of the devices is damaged includes an identifier of the gateway, an identifier of the device, the integrity of which is damaged, and a first attestation value received from the device, the integrity of which is damaged.

13. The method of claim 9, wherein performing the operation for responding to the object, the integrity of which is damaged, is configured to perform the detailed integrity verification on the devices using a second attestation value received from the device, the integrity of which is damaged, and second reference values previously received from the devices and registered in advance.

14. The method of claim 13, wherein performing the operation for responding to the object, the integrity of which is damaged, is configured to decrypt the encrypted second attestation value using a second encryption key previously registered and shared with the device, the integrity of which is damaged.

15. The method of claim 14, wherein performing the operation for responding to the object, the integrity of which is damaged, is configured to:
check whether a change in a state of the object, the integrity of which is damaged, is approved, and
update the first reference value and the second reference value with the first attestation value and the second attestation value, respectively, when it is determined that the change is a previously approved change.

16. The method of claim 15, wherein performing the operation for responding to the object, the integrity of which is damaged, is configured to:
check whether the change in the state of the object, the integrity of which is damaged, is approved, and
perform recovery of the device, the integrity of which is damaged, using the first reference value and the second reference value when it is determined that the change is not a previously approved change.
